(19) United States
(12) Patent Application Publication
(10) Pub. No.: US 2025/0321756 A1
(43) Pub. Date: Oct. 16, 2025

(54) GENERATING INTERACTION SEQUENCE DISRUPTION PREDICTIONS

(71) Applicant: U.S. BANK NATIONAL ASSOCIATION, Cincinnati, OH (US)

(72) Inventors: Giacomo Domeniconi, Long Island City, NY (US); Chris Varghese, Carrollton, TX (US); Samuel Assefa, Washington, DC (US)

(21) Appl. No.: 18/632,950

(22) Filed: Apr. 11, 2024

(51) Int. Cl. G06F 9/451

(52) U.S. Cl. CPC G06F 9/451

(57) ABSTRACT

Apparatuses, systems, methods, and computer program products for generating interaction sequence disruption predictions. The interaction sequence disruption predictions are generated based on event indicators associated with a first domain and a subject entity, and the interaction sequence disruption predictions are associated with a second domain. An interaction sequence disruption prediction model is equipped with an attention mechanism to determine target timeframes of times series data objects generated based on the event indicators. Interaction sequence disruption predictions can include a disruption type, category, sub-category, predicted start time, predicted duration, predicted number of interactions, or a predicted number of actions per unit of time. Interaction sequence disruption predictions can further include a predicted deviation of a quantifiable feature in comparison to the quantifiable feature prior to a start of the predicted interaction sequence disruption.

### FIELD

The present application is generally related to systems, methods, apparatuses, and computer program products for generating interaction sequence disruption predictions in computing environments.

### BACKGROUND

The evolution of ubiquitous computing has led to users interacting with various systems in nearly every aspect of life. The extensive use of computer technology in everyday life has resulted in a vast amount of data, generated by different sources for different purposes, and stored in different formats. Changes in behavior and other causes of disruptions in sequences of such data may be difficult or impossible to predict, particularly for long-term changes in such data. Through applied effort, ingenuity, and innovation, these identified deficiencies and problems have been solved by developing solutions that are configured in accordance with the embodiments of the present disclosure, many examples of which are described in detail herein.

### SUMMARY

Embodiments of the present disclosure are directed to a system, computer readable medium, and computer-implemented method for generating interaction sequence disruption predictions.

A system is provided, comprising one or more processors, and memory having instructions that, when executed by the one or more processors, cause the one or more processors to receive one or more subject event indicators associated with a subject entity and a first domain, wherein the one or more subject event indicators comprise respective timestamps. The instructions, that when executed by the one or more processors, further cause the one or more processors to generate, based at least in part on the one or more subject event indicators and the respective timestamps, a subject time series data object associated with the subject entity. The instructions, that when executed by the one or more processors, further cause the one or more processors to generate, based at least in part on applying an interaction sequence disruption prediction model to the subject time series data object, an interaction sequence disruption prediction associated with a second domain and comprising a subject disruption type and a subject directional indicator.

The instructions, that when executed by the one or more processors, further cause the one or more processors to generate, based at least in part on the interaction sequence disruption prediction, an electronic communication configured for display via a display device, and to transmit the electronic communication to a computing device associated with the subject entity.

The instructions, that when executed by the one or more processors, further cause the one or more processors to generate a plurality of training time series data objects associated with respective entities, wherein each training time series data object comprises one or more event indicators associated with the first domain and comprising respective timestamps.

The instructions, that when executed by the one or more processors, further cause the one or more processors to generate interaction sequence disruption labels for each of the plurality of time series data objects, wherein the interaction sequence disruption labels are associated with the second domain, and comprise disruption types and directional indicators associated with the respective entities, and to train the interaction sequence disruption prediction model with the plurality of time series data objects and the interaction sequence disruption labels, wherein the interaction sequence disruption prediction model is configured to generate interaction sequence disruption predictions.

According to certain embodiments, the interaction sequence disruption prediction model comprises an attention mechanism, wherein training the interaction sequence disruption prediction model comprises, with the attention mechanism, determining attention weights of the one or more event indicators of the plurality of training time series data objects and determining attention weights of one or more event types.

Training the interaction sequence disruption prediction model comprises identifying one or more target timeframes of one or more of the plurality of time series data objects as an indicator of the interaction sequence disruption labels.

The subject time series data object further comprises one or more subject event indicators associated with the second domain, and respective timestamps.

The interaction sequence disruption prediction may include a category, a predicted start time of an interaction sequence disruption, a predicted duration of an interaction sequence disruption, a predicted number of interactions, a predicted number of interactions per unit of time, a quantifiable feature, and a predicted deviation of the quantifiable feature in comparison to the quantifiable feature prior to a start of a predicted interaction sequence disruption.

The instructions, that when executed by the one or more processors, further cause the one or more processors to detect the one or more subject event indicators associated with the subject entity and the first domain based at least in part on monitoring one or more data sources, wherein the interaction sequence disruption prediction is generated in real-time relative to a detection of the one or more subject event indicators in the one or more data sources.

The instructions, that when executed by the one or more processors, further cause the one or more processors to generate an updated subject time series data object by updating the subject time series data object to include additional subject event indicators and respective timestamps received based at least in part on monitoring one or more data sources. The instructions, that when executed by the one or more processors, further cause the one or more processors to generate, responsive to generating the updated subject time series data object, based at least in part on applying the interaction sequence disruption prediction model to the updated subject time series data object, an updated interaction sequence disruption prediction associated with the second domain.

According to certain embodiments, applying the interaction sequence disruption prediction model to the subject time series data object comprises assigning attention weights to the one or more subject event indicators according to an event type of the one or more subject event indicators.

According to certain embodiments, applying the interaction sequence disruption prediction model to the subject time series data object comprises assigning weights to the one or more subject event indicators according to the respective timestamps.

In a circumstance where an event type of one or more of the one or more subject event indicators is unknown, applying the interaction sequence disruption prediction model to the subject time series data object comprises clustering the one or more subject event indicators to generate one or more predicted event types, wherein the interaction sequence disruption prediction is generated further based at least in part on the one or more predicted event types.

A non-transitory computer readable medium is provided, having instructions that, when executed by one or more processors, cause the one or more processors to receive one or more subject event indicators associated with a subject entity and a first domain, wherein the one or more subject event indicators comprise respective timestamps. The instructions, that when executed by the one or more processors, further cause the one or more processors to generate, based at least in part on the one or more subject event indicators and the respective timestamps, a subject time series data object associated with the subject entity. The instructions, that when executed by the one or more processors, further cause the one or more processors to generate, based at least in part on applying an interaction sequence disruption prediction model to the subject time series data object, an interaction sequence disruption prediction associated with a second domain and comprising a subject disruption type and a directional indicator.

The instructions, that when executed by the one or more processors, further cause the one or more processors to generate, based at least in part on the interaction sequence disruption prediction, an electronic communication configured for display via a display device, and to transmit the electronic communication to a computing device associated with the subject entity.

The instructions, that when executed by the one or more processors, further cause the one or more processors to generate a plurality of training time series data objects associated with respective entities, wherein each training time series data object comprises one or more event indicators associated with the first domain and comprising respective timestamps.

The instructions, that when executed by the one or more processors, further cause the one or more processors to generate interaction sequence disruption labels for each of the plurality of time series data objects, wherein the interaction sequence disruption labels are associated with the second domain, and comprise disruption types and directional indicators associated with the respective entities.

The instructions, that when executed by the one or more processors, further cause the one or more processors to train the interaction sequence disruption prediction model with the plurality of time series data objects and the interaction sequence disruption labels, wherein the interaction sequence disruption prediction model is configured to generate interaction sequence disruption predictions.

A computer-implemented method is provided, including receiving one or more subject event indicators associated with a subject entity and a first domain, wherein the one or more subject event indicators comprise respective timestamps. The computer-implemented method further includes generating, based at least in part on the one or more subject event indicators and the respective timestamps, a subject time series data object associated with the subject entity.

The computer-implemented method further includes generating, based at least in part on applying an interaction sequence disruption prediction model to the subject time series data object, an interaction sequence disruption prediction associated with a second domain and comprising a subject disruption type and a directional indicator.

The computer-implemented method further includes generating, based at least in part on the interaction sequence disruption prediction, an electronic communication configured for display via a display device, and transmitting the electronic communication to a computing device associated with the subject entity.

An apparatus is provided, including means for receiving one or more subject event indicators associated with a subject entity and a first domain, wherein the one or more subject event indicators comprise respective timestamps. The apparatus further includes means for generating, based at least in part on the one or more subject event indicators and the respective timestamps, a subject time series data object associated with the subject entity.

The apparatus further includes means for generating, based at least in part on applying an interaction sequence disruption prediction model to the subject time series data object, an interaction sequence disruption prediction associated with a second domain and comprising a subject disruption type and a directional indicator.

The apparatus further includes means for generating, based at least in part on the interaction sequence disruption prediction, an electronic communication configured for display via a display device, and means for transmitting the electronic communication to a computing device associated with the subject entity.

Other embodiments include corresponding systems, methods, and computer programs, configured to perform the operations of the apparatus, encoded on computer storage devices. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system that can benefit from technologies described herein.

FIG. 2 illustrates an example method and operations associated with training an interaction sequence disruption model according to the present disclosure.

FIG. 3 illustrates an example method and operations for generating interaction sequence disruption predictions according to the present disclosure.

FIG. 4 discloses an example computing environment with which aspects of the present disclosure may be implemented.

FIG. 5 illustrates an example machine learning framework that techniques described herein may benefit from or improve on.

FIG. 6-7 illustrate example methods and operations associated with training an interaction sequence disruption model according to the present disclosure.

FIG. 8 illustrates an example method and operations for generating interaction sequence disruption predictions according to the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout.

### Overview

Example embodiments of the present disclosure identify triggers that impact future user interactions, including long-term behaviors. Triggers can be events, actions, situations, or a sequence or combination of those, that can lead to a reaction and ultimately to a change in behavior and corresponding interactions with computing systems. Example embodiments detect moments or events in an individual's lifetime that trigger a long-term change, including disruptions in a sequence of interactions. In this regard, a trend or pattern of a user's interaction with one or more systems may change for a period of time based on a detected trigger.

Example embodiments of the present disclosure provide improvements to computing systems that enable a computing system to implement a methodologies to identify and weight events, or moments in time, that may trigger a real and considerable, such as long-term, change in how the individual or other entity (e.g., change in interaction with one or more computing systems). A change or disruption in a sequence may not merely include purchase-to-purchase correlations, but rather correlations of events to long-term changes in sequences or patterns of interactions a user has with a computing system. Once the event is identified and before the change occurs or becomes entrenched, an intervention can be selected and performed. The intervention can prevent the change from becoming entrenched, attempt to shape what the change is, cause other actions, or combinations thereof.

Some existing methodologies focus on outcomes in the short term, or one-time event outcomes, such as an upsell opportunity, an opportunity for avoiding a loss of sale, or an opportunity to provide information that improves the customer experience. Some examples include:
A purchase of a flight ticket may trigger a one-time purchase of a hotel room. Such methods merely look for correlations between purchases or are recommender systems that retrieve frequent sequences of purchases.
A user browses an online store going through the men's catalog for general wear, ends up not making any purchase and closing the webpage, triggering a message introducing them to other men's products available. This is often a one-time prompt or recommendation generated from a single browsing session.
Financial institutions use a transaction trigger such that when a customer makes a withdrawal or deposit to their account, they receive the transaction details in the message inbox.

Example embodiments of the present disclosure include improvements to computing systems (e.g., improvements to or arrangements of neural networks and attention maps) that enable systems and methods to retrieve and weight events that trigger changes in interaction sequences. Example embodiments train a model utilizing historical data including but not limited to:
Data related to a first domain, such as non-monetary events, life events, or the like. The event data related to the first domain may include event sequences, or asynchronous time-series data, such as but not limited to an address change, a call to the customer service, a reported fraud, etc. This type of data may be explicitly available from one or a plurality of different data sources (for example from a customer service database table, a fraud reports table, etc.). The event sequences or asynchronous time-series data can be formatted according to techniques described in U.S. patent application Ser. No. 18/449,257, which was filed Aug. 14, 2023, and which is incorporated herein by reference in its entirety for any and all purposes. Additionally, the data associated with the first domain, such as non-monetary data, or event data, may be implicitly available in one or more data sources as latent information. In this case a rule-based model can retrieve latent events. For example, the event data relating to the first domain may be obtained by accessing historical demographic data and retrieving the moment in which a user changes a trait in their demographic (e.g. change in marital status, change in address, change in payment method, new mortgage opened, help center call, birth of a child, graduation, promotion, retirement, car registration, car lease signing, job loss, starting of a business, etc.). Another example of event associated with the first domain may include latent events such as an addition, removal, or change of a payment method to a digital wallet.
Data associated with a second domain, such as but not limited to transaction or monetary events data. Data associated with a second domain can include transactional and purchase data sequences (also called asynchronous time-series), or purchasing history in a website, etc. The data associated with a second domain may be obtained from a transactional data source, such as a transactional database, credit card transaction record, account transaction table, or the like. In some examples, the data associated with the second domain also includes activity data. Activity data can include sequential data that is not merely monetary. For example, activity data can include browsing data.

Example embodiments utilize the data from the first domain, and optionally the second domain, to predict interaction sequence disruptions associated with the second domain. In this regard, a disruption in interactions, such as a long-term change in interactions indicative of transactions, monetary spending, investing, or the like, may be predicted. Examples of such interaction sequence disruption predictions associated with the second domain may include, but are not limited to:
Entity attritting or churning by dropping of a certain amount (or percentage) its purchases or activities in a time window. May include a predicted account closing or cancellation.
Entity increasing its purchases.
Entity dropping or increasing purchases values, or numbers in specific categories of sales (for example dropping their spending in dining).
Having defined spending segments or clusters, any migration between different segments of an entity, in either positive or negative paths.

While many examples are described herein are transactional, embodiments need not be so limited. Further, while examples herein may involve transactional data, the instant claims may not necessarily be directed to such transactions. Rather, claims may be directed to, for example, improvements to computing systems in their ability to efficiently and effectively process data and produce useful output in ways that computing systems lacking such techniques cannot.

In an example, techniques can be applied to non-transactional data. For example, the first domain may include event sequences or asynchronous time-series data related to human behavior. Examples of human behavior, include data related to health of a human. Such data can include health data obtained by implanted, wearable, or external sensors, including movement data (e.g., steps per day, activity level, and gait characteristics), sleep data (e.g., hours and quality of sleep), organ function data (e.g., heart rate), biological markers (e.g., blood glucose levels), other health data (e.g., weight), or combinations thereof. Corresponding second domain data may include acute or chronic health effects.

While many examples are directed to behavior of a human user, techniques described herein can be applied to an artificial user (e.g., an artificial intelligence agent). Changes in behavior of the artificial user (e.g., changes in output in response to input) can be used to indicate beneficial or detrimental second domain changes for which intervention is appropriate to improve the functioning of the artificial user or resist deterioration of the artificial user.

Example embodiments of the present disclosure use a model including a neural network, trained using the events from the first domain as input, to recognize and predict the interaction changes associated with the second domain such that interaction sequence disruption predictions associated with the second domain are generated by the model. Input to the model may optionally include data associated with the second domain. In some embodiments, the input to the model may be one event associated with the first domain, such as a non-monetary event, or it may be a sequence of events associated with the first domain and having occurred in a certain time window Tᵢₙ (where Tᵢₙ may depend on a business context, from hours or days to months), including one or more events associated with the first domain and optionally data associated with the second domain. The output or label of the model includes a prediction regarding an interaction sequence disruption, representing a predicted customer behavioral change with regard to interactions associated with the second domain, in a Tₒᵤₜ time window. Tₒᵤₜ may be defined as equal to Tᵢₙ, to consider interaction disruptions occurring in real-time relative to a trigger, or it may be a future time window, to consider interaction disruptions that occur after a trigger.

Example embodiments provided herein do not necessarily rely on any specific neural network architecture or model, but utilize a model equipped with an attention mechanism to weight the impact of certain events or event type in affecting interactions associated with the second domain. Accordingly, given an input sample, a model according to example embodiments provides the output probability (the likelihood of the sample to be in each possible output category or classification relating to an interaction sequence disruption prediction). The model further provides an attention map to assign an importance score of each portion of the input sample, in this case the importance score of each event in the input used by the model to classify the input with regard to a predicted output, such as relating to an interaction sequence disruption prediction.

According to certain embodiments, the model may include a neural network such as a recurrent neural network (RNN), gated recurrent unit (GRU) or long short-term memory (LSTM), equipped with attention mechanisms, such as Luong temporal attention or Bahdanau temporal attention. In certain embodiments the neural network may be a transformer-based model and the attention may be given intrinsically by the self-attention layers. The model may be trained to recognize and predict the interaction sequence disruptions with regard to a second domain, given the events associated with the first domain.

Certain example contexts and use cases are given for the application of the various embodiments disclosed herein, and one will appreciate, in light of the present disclosure, that these contexts and use cases, while improvements themselves, also provide examples of underlying improvements of the present disclosure (e.g., improved neural networks, neural network training, neural network weighting, disruption prediction, etc.) that may be used with other contexts and use cases.

### Example Terminology

As used herein, the terms “data,” “content,” “digital content,” “digital content object,” “information,” and similar terms may be used interchangeably to refer to data capable of being transmitted, received, and stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and the like.

The term “subject entity” refers to one or more individuals, joint account owners, families, business, etc. for which an interaction sequence disruption prediction is made or requested to be made and may include any identifying information of thereof such as unique identifiers, combinations of data such as name and date of birth, and the like. A subject entity may be associated with a subject entity identifier. A subject entity identifier may refer to one or more items of data by which a subject entity may be uniquely identified. A subject entity may have an associated profile or entity profile data including demographic information and the like.

The term “event indicators” refers to any electronic data representative of an instance of an electronic event occurring in association with a particular entity. A “subject event indicator” indicates an event that occurs in association with the subject entity. An event indicator may include a timestamp indicating a date and time the event occurred, and an event type. An event indicator may be generated based at least in part on one or more of entity profile data, customer service data, demographic data, property ownership records, jurisdictional incorporations data, or education data, received from one or more data sources. Additionally, or alternatively, an event indicator may be generated based on a change to one or more fields relating to the aforementioned data fields, which are not intended to be limiting. The event indicators may be generated or stored by a data source other than a transactional data source. In this regard, a transactional data source is often not configured to store event indicators or non-monetary data.

The term “timestamp” refers to any data representation of a date, a time, or combination thereof (e.g., a network timestamp).

The term “event type” refers to a data representation of an event category or a classification of an event represented by an event indicator. An event type may refer to a marital status change, an address change, a new account opening, a customer service communication, a change in familial status, an educational status change, an employment status change, or a new business indicator, etc.

The term “time series data object” refers to a collection of one or more event indicators and respective timestamps associated with a particular entity. A “subject time series data object” therefore refers to a time series data object associated with a subject entity. A “training time series data object” refers to a time series data object associated with a training entity, such as for which an interaction sequence disruption label is known and utilized in training as described herein.

The term “interaction” refers to an identifiable, non-transitory occurrence that has technical significance for one or both of system hardware and software. An interaction may be user-generated, such as keystrokes or mouse movements, such as those that results in or are associated with approval of a purchase, confirmation of an investment, swiping of a credit card, positioning of a credit card including a chip to be read by a chip-reader, etc. An interaction may be associated with the second domain, such as monetary transactions. An interaction sequence may therefore include a series of interactions associated with the second domain, such as a credit card transaction history, account history, or the like.

The term “interaction sequence disruption prediction” refers to a data object indicative of a predicted disruption in a sequence of interactions and may indicate a predicted future or impending disruption in a current trend or pattern of a sequence of interactions. Attributes of the interaction sequence disruption prediction may include a directional indicator, a disruption type (a category and optional subcategory), a predicted start date or time, a predicted duration, a quantifiable feature, a predicted deviation of the quantifiable feature, a predicted number of interactions, and a predicted number of interactions per unit of time.

The term “directional indicator” refers to an indication of an increase or decrease, such as a predicted increase or predicted decrease of a quantifiable feature (described in further detail below) indicated by the interaction sequence disruption prediction. A “subject directional indicator” refers to a particular directional indicator predicted for a subject entity.

The term “disruption type” refers to a category and an optional subcategory describing a change in an interaction sequence. A category may include any classification to which the interaction sequence disruption prediction applies, such as but not limited to spending, deposits, withdrawals, speed, etc. As examples, subcategories associated with a spending category may include dining spending, home improvement spending, childcare spending, child related spending, etc. Subcategories associated with deposits or withdrawals may include stock, mutual fund, retirement accounts, etc. A “subject disruption type” refers to a particular disruption type predicted for a subject entity.

The term “predicted start date or time” refers to a date or time (e.g., a network time stamp) the interaction sequence disruption is predicted to begin.

The term “predicted duration” refers to an estimated time period of the interaction sequence disruption before the interaction sequence returns to reflect a trend or pattern of the interaction sequence prior to the predicted disruption. Additionally or alternatively, the interaction sequence disruption prediction includes a predicted end date or end time. According to example, an interaction sequence disruption prediction may include an increase in spending for a predicted duration of one-year, for example.

The term “quantifiable feature” refers to a feature measurable in a numeric representation. For example, a quantifiable feature may include dollars spent, dollars invested, dollars withdrawn, a speed of a vehicle, webpages visited, products viewed, items added into digital cart, cart items abandoned, etc.

The term “predicted deviation of the quantifiable feature” refers to an estimated quantifiable change in the quantifiable feature in comparison to the quantifiable feature prior to a start of a predicted interaction sequence disruption. For example, a predicted deviation may include of a $3,000 per year increase in predicted purchases in the home improvement category.

An example predicted deviation of the quantifiable feature may include a prediction that interactions will differ from a current or prior trend of interactions for an entity, such as an increase in purchases in the home improvement category by 4 transactions per month. As another example, an interaction sequence disruption prediction may further include a prediction of a vehicle speeding 10 miles per hour over a speed limit for the next 10 minutes of driving in comparison to the vehicle previously following the speed limit.

The term “predicted number of interactions” refers to a quantity of interactions estimated to occur with regard to the interaction sequence disruption prediction.

The term “predicted number of interactions per unit of time” refers to a quantity of interactions estimated to occur within a specified time period, with regard to the interaction sequence disruption prediction. For example, a predicted number of interactions per unit of time may include 10 transactions per month.

In this regard, the interaction sequence disruption prediction may include an interaction sequence disruption prediction plot or curve including a predicted number of interactions per unit of time over a duration, a total of a quantifiable feature per unit of time over a duration (e.g., dollars spent per month), etc. which may vary in particular subperiods or timeframes.

Accordingly, any data representations and any combinations of attributes, such as a directional indicator, a disruption type, a predicted start time, a predicted duration, a quantifiable feature, a predicted deviation of a quantifiable feature, a predicted number of interactions, a predicted number of interactions per unit of time, etc. may be included in the interaction sequence disruption prediction. The disruption, or change, from a current or prior trend of interactions may be predicted to occur in a future sequence of interactions, in one or more of the quantifiable features, the predicted number of interactions, or the predicted number of interactions per unit of time.

The term “trigger” refers to an electronic signal indicating an event or event type identified as impacting or causing an interaction sequence prediction to be generated, That is, upon receipt of an electronic signal representative of a trigger, a series of executing various operations may be initiated. A trigger may be associated with a trigger identifier, which may be one or more items of data by which a trigger may be uniquely identified.

The term “interaction sequence disruption label” refers to a variation of an interaction sequence disruption prediction but includes known and true data associated with a one or more training series data objects and a respective entity. The interaction sequence disruption label may therefore include any attributes included in an interaction sequence disruption prediction and is used to train the interaction sequence disruption prediction model to generate other interaction sequence disruption predictions based on a subject time series data object. According to certain embodiments, an interaction sequence disruption label may indicate ‘false,’ indicating no interaction sequence disruption was identified, and such that attributes of the interaction sequence disruption prediction may be ‘null’ or the interaction sequence disruption prediction excluded from the training method. In certain embodiments, interaction sequence disruption labels indicating ‘false’ may be excluded from the training method.

The term “interaction sequence disruption prediction model” refers to a machine learning model, including data representations of nodes (e.g., neural network nodes, decision tree nodes, Markov model nodes, other nodes, or combinations thereof) and connections between nodes (e.g., weighted or unweighted unidirectional or bidirectional connections). In certain embodiments, the interaction sequence disruption prediction model includes a representation of memory (e.g., providing long short-term memory functionality). Training and use of the interaction sequence disruption prediction model is described herein. Output of the model may vary according to implementation. According to certain embodiments, a probability may be output for a plurality of categories, indicating a probability that the input data set results in an interaction sequence disruption with regard to a particular category (e.g., retirement contributions, restaurant spending, home improvement spending, etc.). According to certain embodiments, a probability may be output indicating a probability of an interaction sequence disruption occurring (without a category specified). According to certain embodiments, the output of the interaction sequence disruption prediction model may include any attributes of an interaction sequence disruption prediction. An output distribution may include a plurality of probabilities of certain categories of interaction sequence disruption occurring.

The term “attention mechanisr” refers to a collection of data and software of the interaction sequence disruption prediction model that allows the interaction sequence disruption prediction model to focus on and assign attention weights to specific portions of input, such as time series data objects. The attention mechanism may be employed during the training of the interaction sequence disruption prediction model to generate the weights and store the weights in an attention map to be used during application of the interaction sequence disruption prediction model to real-world data in order to generate interaction sequence disruption predictions. The attention mechanism may include a Luong temporal attention mechanism, or Bahdanau temporal attention mechanism, self-attention layers of a transformer model, or the like.

The term “target timeframe” refers to a portion of a time series data object determined by application of the interaction sequence disruption prediction model to be relevant, or most relevant, in the predicting of an interaction sequence disruption.

The term “interaction sequence disruption prediction threshold” refers to a measurable data component used for comparison of outputs of the interaction sequence disruption prediction model to determine whether an interaction sequence disruption prediction is generated. For example, if an interaction sequence disruption prediction threshold is a change in spending by at least $2,000 per year, and an output produced by the interaction sequence disruption prediction model included a predicted change of $3,000 per year, an interaction sequence disruption prediction is generated, optionally including an indicator set to ‘true,’ but if an output includes a predicted change of $500 per year, an interaction sequence disruption prediction is not generated, or is generated with an indicator set to ‘false.’

The term “domain” refers to characteristics of the associated data, such as characteristics of event indicators, interaction sequence disruption predictions, and interaction sequence disruption labels. According to certain embodiments, the term domain refers to a common characteristic among a plurality of data points. According to certain example embodiments, data associated with one domain may have first common characteristic, and the data associated with a different domain may lack the first common characteristic.

For example, a first domain may be associated with data without a monetary feature or without a quantifiable feature such that the first domain is associated with events such as a marital status change, an address change, a new account opening, a customer service communication, a change in familial status, an educational status change, an employment status change, or a new business indicator, a navigational instruction to enter a highway, etc. In this regard the first domain excludes data having a monetary feature. In contrast, a second domain may be associated with data including a monetary feature or a quantifiable feature, including dollars spent, dollars invested, dollars withdrawn, speed, etc. Event indicators, interaction sequence disruption predictions, and interaction sequence disruption labels associated with the second domain may therefore include one or more numerical values, such as but not limited to a monetary amount, a speed, or the like. According to certain embodiments, data associated with a first domain may be in a different format than data associated with a second domain. For example, data associated with the first domain may include an event type and timestamp, whereas data associated with the second domain may include a dollar amount such as a credit or debit amount and a timestamp.

The term “transactional data” refers to data comprising a quantifiable monetary feature. Examples of transactional data may include purchases, withdrawals, contributions, etc. The transactional data may include an amount, a retailer name, a category and optional subcategory of the retailer, a financial institution responsible for performing any of the payment processing or disbursement, identifying information of the entity that initiated the associated transaction, and the like.

The term “transactional data source” refers to a system affiliated with a transaction system (e.g., a financial transaction system, a retail transaction system, another kind of transaction system, or combinations thereof) and configured to store, maintain and provide transactional data. The transactional data source may be affiliated with or operated by a bank, lender, credit card company, investment institution, or the like, such as one that issues credit cards to cardholders, and facilitates authorization, settlement and funding.

The term “electronic communication” refers to electronic data configured to be transmitted from one computing device to another computing device. The electronic communication may be readable the receiving device to produce output discernable by a user. For example, the electronic communication can include electronic mail, secure messaging, rendering by an application or website, etc.

### Example System Architecture

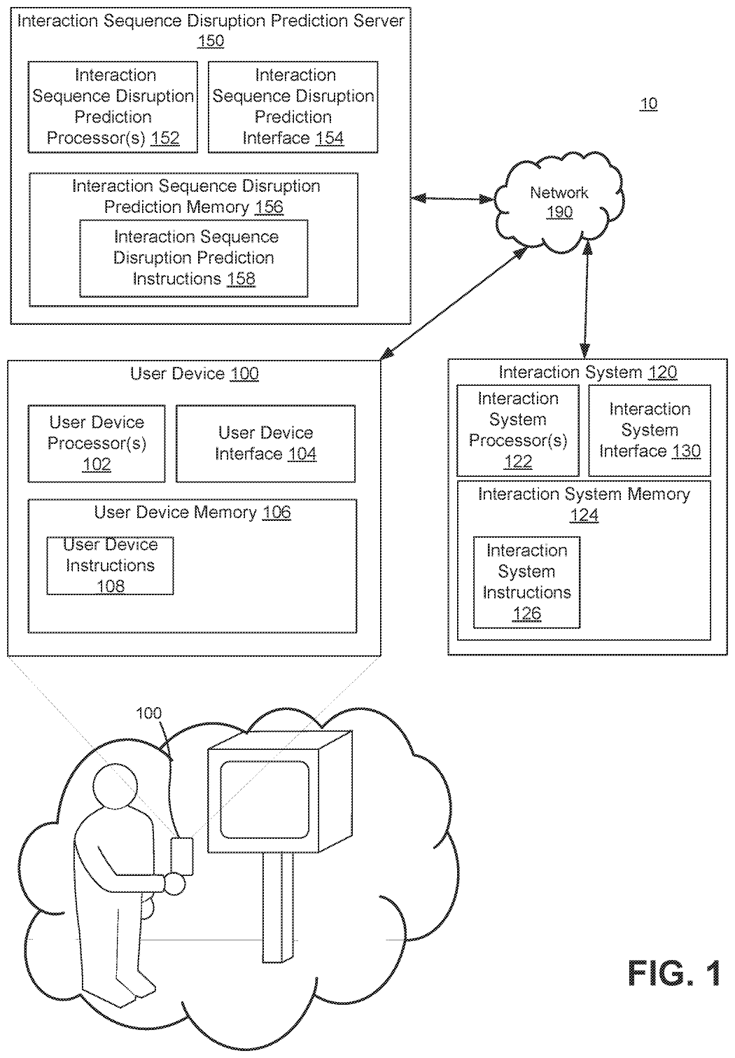

Methods, apparatuses, and computer program products of the present disclosure may be embodied by any of a variety of devices. For example, the method, apparatus, and computer program product of an example embodiment may be embodied by a networked device, such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile devices, personal computer, laptop computer, tablet, or the like. An example system that can be used according to examples herein is described in FIG. 1.

FIG. 1 illustrates a system 10 configured to predict interaction sequence disruptions, according to example embodiments. The system includes one or more user devices 100, one or more interaction systems 120, and one or more interaction sequence disruption servers 150 connected to a network.

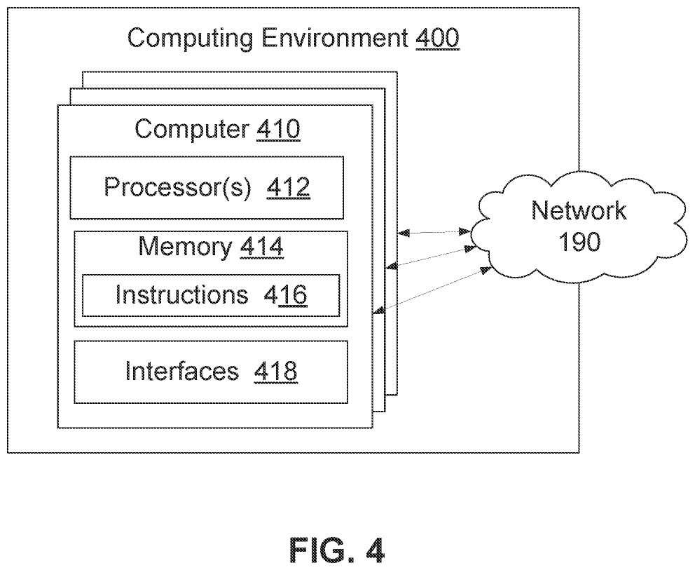

The user device 100 is a device used by a user that can be used as part of processes described herein. The user device 100 can include one or more aspects described elsewhere herein such as in reference to the computing environment 400 of FIG. 4. In many examples, the user device 100 is a personal computing device, such as a smart phone, tablet, laptop computer, or desktop computer. But the device 100 need not be so limited and may instead encompass other devices used by a user as part of processes described herein. For instance, with respect to data creation, other devices can generate data or cause data to be generated, such as credit cards, cash, digital wallets, or smart televisions, other devices, or combinations thereof. With respect to receiving output of the system (e.g., to influence a predicted change), physical mail, phone calls, or other techniques can be used.

In the illustrated example, the user device 100 can include one or more user device processors 102, one or more user device interfaces 104, and user device memory 106, among other components.

The one or more user device processors 102 are one or more components of the user device 100 that execute instructions, such as instructions that obtain data, process the data, and provide output based on the processing. The one or more user device processors 102 can include one or more aspects described below in relation to the one or more processors 412 of FIG. 4.

The one or more user device interfaces 104 are one or more components of the user device 100 that facilitate receiving input from and providing output to something external to the user device 100. The one or more user device interfaces 104 can include one or more aspects described below in relation to the one or more interfaces 418 of FIG. 4.

The user device memory 106 is a collection of one or more components of the user device 100 configured to store instructions and data for later retrieval and use. The user device memory 106 can include one or more aspects described below in relation to the memory 414 of FIG. 4. As illustrated, the user device memory 106 stores user device instructions 108 and the user device code 110.

The user device instructions 108 are a set of instructions that, when executed by one or more of the one or more user device processors 102, cause the one or more user device processors 102 to perform an operation described herein. In examples, the instructions 112 can be those of a mobile application (e.g., that may be obtained from a mobile application store, such as the APPLE APP STORE or the GOOGLE PLAY STORE). The mobile application can provide a user interface for receiving user input from a user and acting in response thereto. The user interface can further provide output to the user. In some examples, the user device instructions 108 are instructions that cause a web browser of the user device 100 to render a web page associated with a process described herein. The web page may present information to the user and be configured to receive input from the user and take actions in response thereto.

The interaction system 120 is any computing device that facilitates interactions via the user device 100. In this regard, the user device 100 may be a client device in communication with an interaction system 120 implemented as a server. The interaction system 120 may further provide data to the interaction sequence disruption prediction server 150 to enable the interaction sequence disruption prediction server 150 to predict interaction sequence disruptions, as described in further detail herein. According to certain embodiments, the interaction system 120 may be embodied as a distributed system.

In the illustrated example, the interaction system 120 includes one or more interaction system processors 122, interaction system memory 124, and an interaction system interface 130.

The one or more other interaction system processors 122 are one or more components of the interaction system 120 that execute instructions, such as instructions that obtain data, process the data, and provide output based on the processing. The one or more interaction system processors 122 can include one or more aspects described below in relation to the one or more processors 412 of FIG. 4.

The interaction system memory 124 is a collection of one or more components of the interaction system 120 configured to store instructions and data for later retrieval and use. The interaction system memory 124 can include one or more aspects described below in relation to the memory 414 of FIG. 4. The interaction system memory 124 can store interaction system instructions 126.

The interaction system instructions 126 are instructions that, when executed by the one or more interaction system processors 122, cause the one or more interaction system processors 122 to perform one or more operations described elsewhere herein.

The one or more interaction system interfaces 130 are one or more components of the interaction system 120 that facilitate receiving input from and providing output to something external to the interaction system 120. The one or more interaction system interfaces 130 can include one or more aspects described below in relation to the one or more interfaces 418 of FIG. 4.

The interaction system 120 may be implemented for a variety of uses and in association with a variety of domains. For example, the interaction system 120 may host one or more applications on behalf of a business or organization. In another example, the interaction system 120 may include a system for facilitating operation of a vehicle, where the user interacts with one or more components that directly or indirectly control one or more computer components to operate certain functionality of a vehicle. According to certain example embodiments, the interaction system 120 includes a financial system, such as or including a transactional system that facilitates the purchasing of goods, services and the like by various entities. The interaction system 120 may be operated by a bank, lender, credit card company, financial institution, investment institution, or the like, such as one that issues credit cards to cardholders, and facilitates authorization, settlement and funding. The interaction system 120 may further facilitate communication and transactions with one or more payment processors, merchant banks, merchant accounts, or the like, and may accept payments from cardholders to be credited towards a cardholders' debt. According to certain embodiments, the interaction system 120 may facilitate transactions associated with one or more bank accounts, such as a checking or savings account. According to certain embodiments, the interaction system 120 may facilitate brokerage transactions, mutual fund transactions, and the like.

In any event, the interaction system 120, such as a transactional system, may maintain and update various records associated with user interactions, including transactional records, monetary records, purchase history, investment records, account openings, account closures, and the like, in interaction system memory 124. According to certain embodiments the data may be associated with an individual, or another entity. Accordingly, the data stored on interaction system memory 124 may indicate a new organizational (e.g., business, charity, or social group) or personal opening by an individual, and the like.

According to certain embodiments, the user device 100 need not interact directly with the interaction system 120, but the user device 100 may interact with one or more intermediary systems, such as a retailer's website, mobile application, or point-of-sale device, which in turn communicates with the interaction system 120. For example, a user device 100 may initiate purchases via one or more websites, mobile application, or devices using a credit or debit card, and an associated transaction is routed and processed by the website, merchant, payment processor, and the like. The data stored in the interaction system memory 124 may therefore be associated with transactional and monetary data but is further associated with user interactions made via user device 100.

The interaction system 120 may include an application server configured to facilitate creation and modification of a user profile, user demographic information and the like. A user may therefore use the user device 100 to indicate a marital status, address change, familial status, employment status, or the like. Accordingly, the interaction system memory 124 may include data indicating such statuses.

According to certain embodiments, the interaction system 120 may be operated by a same business entity as the interaction sequence disruption prediction server 150. However, according to certain embodiments, the interaction system 120 may be operated by a different business entity as the interaction sequence disruption prediction server 150, such that the interaction system 120 is a third-party system or external system. In this regard, the interaction system 120 may process and store any data pertaining to user interaction with a device, by one or more individuals or entities. The interaction system 120 may therefore include one or more public record systems, marketing systems, or the like.

The interaction sequence disruption prediction server 150 is a server that functions as part of one or more processes described herein. In the illustrated example, the interaction sequence disruption prediction server 150 includes one or more interaction sequence disruption prediction processors 152, one or more interaction sequence disruption prediction interfaces 154, and interaction sequence disruption prediction memory 156, among other components.

The one or more interaction sequence disruption prediction processors 152 are one or more components of the interaction sequence disruption prediction server 150 that execute instructions, such as instructions that obtain data, process the data, and provide output based on the processing. The one or more interaction sequence disruption prediction processors 152 can include one or more aspects described below in relation to the one or more processors 412 of FIG. 4.

The one or more interaction sequence disruption prediction interfaces 154 are one or more components of the interaction sequence disruption prediction server 150 that facilitate receiving input from and providing output to something external to the interaction sequence disruption prediction server 150. The one or more interaction sequence disruption prediction interfaces 154 can include one or more aspects described below in relation to the one or more interfaces 418 of FIG. 4.

The interaction sequence disruption prediction memory 156 is a collection of one or more components of the interaction sequence disruption prediction server 150 configured to store instructions and data for later retrieval and use. The interaction sequence disruption prediction memory 156 can include one or more aspects described below in relation to the memory 414 of FIG. 4. The interaction sequence disruption prediction memory 156 can store interaction sequence disruption prediction instructions 158.

The interaction sequence disruption prediction memory 156 may further include an interaction sequence disruption prediction model, trained by the interaction sequence disruption prediction server 150 according to example embodiments disclosed herein to predict interaction sequence disruptions.

The interaction sequence disruption prediction instructions 158 are instructions that, when executed by the one or more interaction sequence disruption prediction processors 152, cause the one or more interaction sequence disruption prediction processors 152 to perform one or more operations described elsewhere herein.

The network 190 is a set of devices that facilitate communication from a sender to a destination, such as by implementing communication protocols. The network 190 is a set of devices that facilitate communication from a sender to a destination, such as by implementing communication protocols. Example networks 190 include local area networks, wide area networks, private networks such as an intranet, public networks such as the Internet, or any combination thereof. The network 190 may include any wired or wireless communication network including, for example, a wired or wireless local area network (LAN), personal area network (PAN), metropolitan area network (MAN), wide area network (WAN), or the like, as well as any hardware, software and firmware required to implement it (such as, e.g., network routers, etc.). For example, communications network 190 may include a cellular telephone, an 802.11, 802.16, 802.20, or WiMax network. The network 190 may utilize a variety of networking protocols now available or later developed including, but not limited to Transmission Control Protocol, Internet Protocol, etc.

### Example Methods

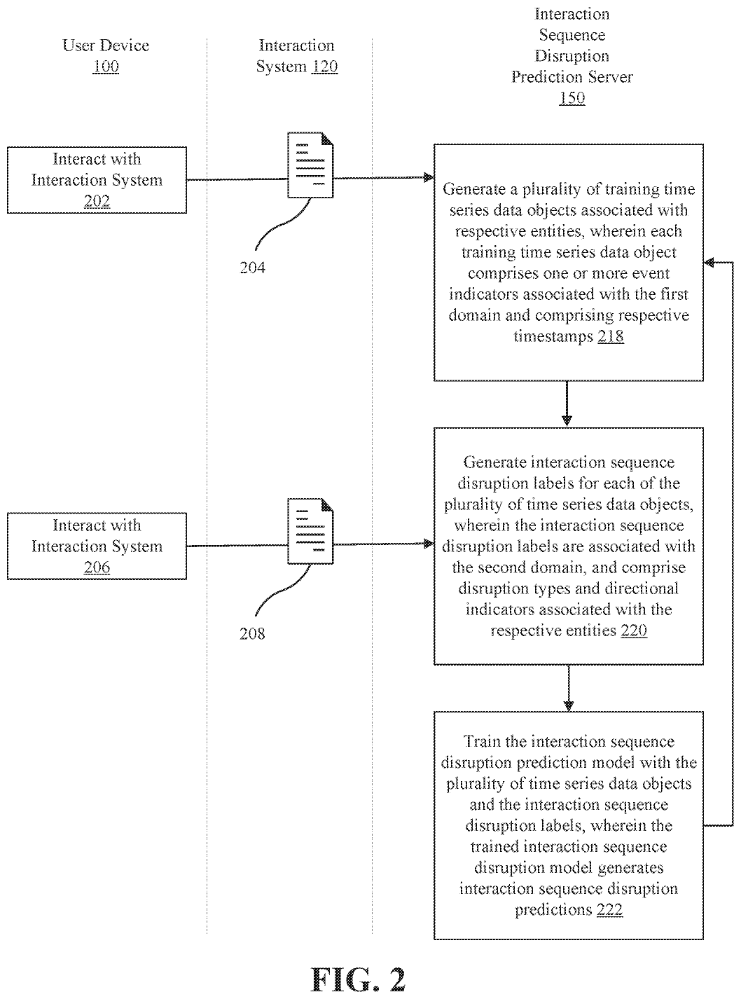

FIG. 2 illustrates an example method for training an interaction sequence disruption prediction model with an interaction sequence disruption server 150 according to example embodiments.

At operation 202, the user device 100 interacts with the interaction system 120. For example, the user device 100 accesses a user profile to indicate a marital status change, a change of address or any other data indicative of event associated with the first domain. The interaction system 120 may then generate, store and/or receive one or more event indicators 204, and communicate the one or more event indicators to the interaction sequence disruption prediction server 150. The one or more event indicators 204 are associated with an entity and include timestamps indicating a date and time the event occurred for the entity.

According to certain embodiments, the one or more event indicators 204 need not be explicitly provided by the user device 100, but an interaction with the interaction system 120 via the user device 100 may result in processing of certain data by the interaction system 120, and generation of one or more event indicators 204 for provision to the interaction sequence disruption prediction server 150.

Operation 206 includes user device 100 interacting with an interaction system 120 to cause the generation of data 208 associated with the second domain. According to certain embodiments, operation 206 may occur independently of operation 202, and may occur with a same or different instance of a user device 100. Similarly, the interaction of operation 206 may occur with a same or different instance of an interaction system 120 than referenced in operation 202. According to an example, in operation 206, the user device 100 may interact with an interaction system 120, such as an interaction system implemented as a financial institution system or transactional system, by making purchases at various merchants and using a credit card issued by a financial institution associated with the financial institutional system. The data 208 may be representative of other interactions between a user device 100 and interaction system 120. The data 208 associated with the second domain may therefore include transactional data, monetary data, and the like.

At operation 218, the interaction sequence disruption prediction server 150 generates a plurality of training time series data objects associated with respective entities, wherein each training time series data object comprises one or more event indicators associated with the first domain and comprising respective timestamps. The training time series data objects may indicate multiple events including an entire history of data associated with the entity, or a subset of available data. The training time series data objects may be updated over time as additional event indicators associated with a respective entity are received. The training time series data objects may be stored and maintained on interaction sequence disruption prediction memory 156.

At operation 220, the interaction sequence disruption prediction server 150 generates interaction sequence disruption labels for each of the plurality of time series data objects, wherein the interaction sequence disruption labels are associated with the second domain and comprise a category (e.g., spending, home improvement spending, restaurant spending, etc.) and directional indicators associated with the respective entities. The interaction sequence disruption labels may include any data fields included in an interaction sequence disruption prediction but relate to known data associated with the respective entity and the second domain, such as data including or generated based on data 208. For example, the interaction sequence disruption labels may be generated based on one or more monetary or transactional data and may indicate an increase in spending over a particular time window, or an increase in spending in a particular spending category over a particular time window.

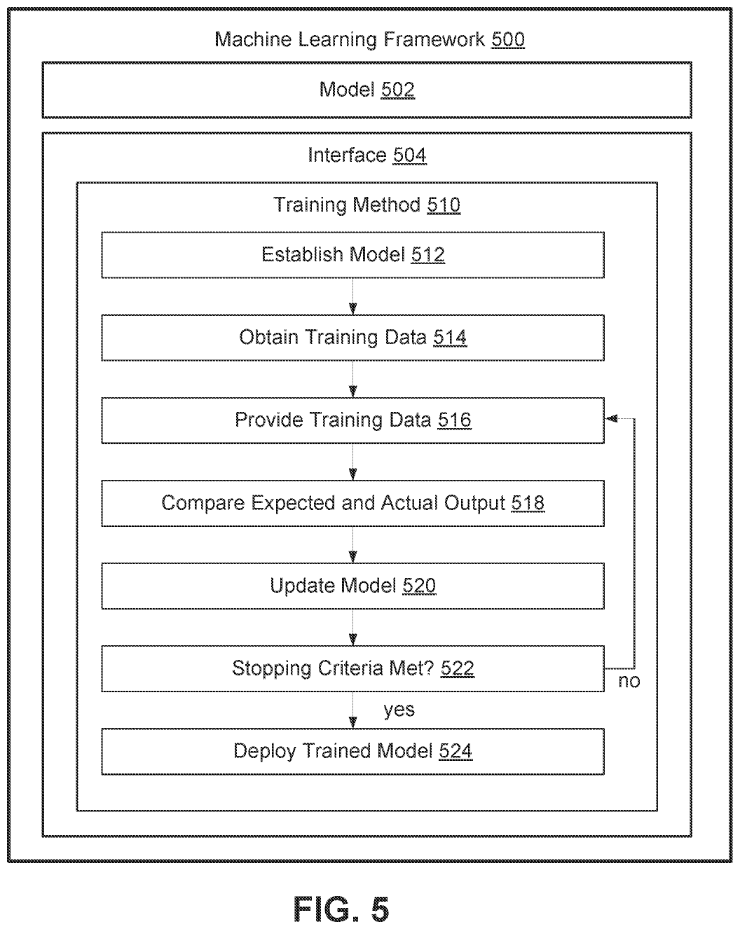

In operation 222, the interaction sequence disruption prediction server 150 trains the interaction sequence disruption prediction model with the plurality of time series data objects and the interaction sequence disruption labels, wherein the interaction sequence disruption prediction model generates interaction sequence disruption predictions. Training of the interaction sequence disruption prediction model is described in further detail herein, such as with respect to FIGS. 5-8. According to certain embodiments, the flow may return to operation 218, and certain operations of FIG. 2 may be repeated, such as on an ongoing basis, or as additional event indicators 204 associated with the first domain, and data 208 associated with the second domain are received from the interaction system 120. In this regard, time series data objects may be updated or regenerated, and their respective interaction sequence disruption labels updated or regenerated. The interaction sequence disruption prediction model may therefore be trained with additional data on an ongoing basis, on a routine interval, in real-time as the data is received, or the like. The trained interaction sequence disruption prediction model may be used to generate interaction sequence disruption prediction as disclosed herein.

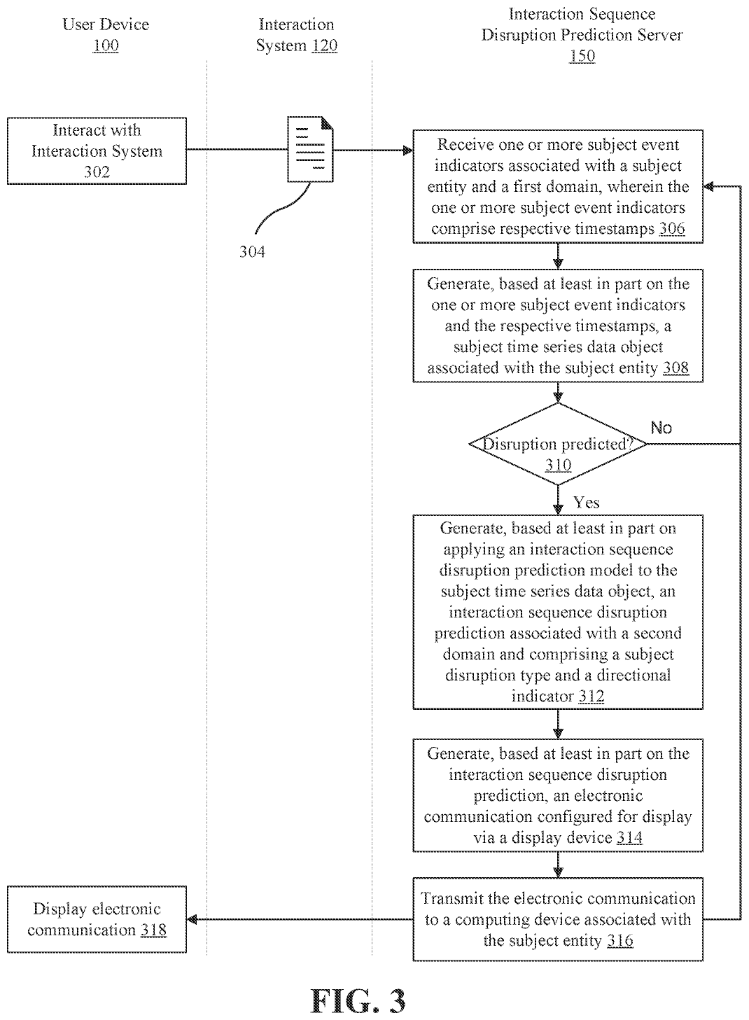

FIG. 3 illustrates an example method for generating an interaction sequence disruption prediction. Operation 302 includes the user device 100 interacting with the interaction system 120. For example, the user device 100 accesses a user profile to indicate a marital status change, address change, or data indicative of another event type, such that event indicators 304 are generated, processed and stored by the interaction system 120, and communicated to the interaction sequence disruption prediction server 150. The event indicators 304 are associated with a subject entity, a first domain, and include timestamps.

As shown by operation 306, the interaction sequence disruption prediction server 150 receives one or more subject event indicators associated with a subject entity and a first domain, wherein the one or more subject event indicators comprise respective timestamps.

As shown by operation 308, the interaction sequence disruption prediction server 150 generates, based at least in part on the one or more subject event indicators and the respective timestamps, a subject time series data object associated with the subject entity. The time series data objects may indicate multiple events including an entire history of data associated with the entity, or a subset of available data. Although not shown in FIG. 3, the time series data object may optionally include data associated with the second domain. However, according to certain embodiments, the time series data object excludes data associated with the second domain, such as monetary and transactional data.

As shown by operation 310, the interaction sequence disruption prediction server 150 applies the subject time series data object associated with the subject entity to determine whether an interaction sequence disruption is predicted for the subject entity. According to certain embodiments, this may include comparing a value output by the interaction sequence disruption prediction model to the interaction sequence disruption prediction threshold, to determine if the value meets or exceeds the interaction sequence disruption prediction threshold. If not, the interaction sequence disruption prediction server 150 can return to operation 306, such as by repeating the operations for the subject entity, such as based on additionally received event indicators, or for other entities. In this regard, the interaction sequence disruption prediction server 150 may continually or repeatedly receive new event indicators for a plurality of subject entities and perform the operations of FIG. 3 to determine if an interaction sequence disruption is predicted for any entity.

As shown by operation 312, in circumstances in which an interaction sequence disruption is predicted, the interaction sequence disruption prediction server 150 generates, based at least in part on applying the interaction sequence disruption prediction model to the subject time series data object, an interaction sequence disruption prediction associated with a second domain and comprising a subject disruption type (e.g., a category and optional subcategory) and a directional indicator.

According to certain embodiments, applying the interaction sequence disruption prediction model to the subject time series data object comprises assigning weights to the one or more subject event indicators according to the respective timestamps. As discussed with regard to FIG. 2, FIGS. 5-7, the training and updating of the interaction sequence disruption prediction model, the interaction sequence disruption prediction model includes determining weights for event indicators, which may be based on a respective event type, and their respective positions with respect to time in a time series data object, or their respective positions in time with respect to other events such as events associated with the first domain, transactions such as monetary transactions associated with a second domain, or the like. The interaction sequence disruption prediction model is therefore trained and updated as described in further detail herein, to provide weights to be applied to certain events in a subject time series data object.

Operations 310 and 312, and the process flow therebetween, may be implemented in a variety of ways. For example, in certain embodiments, as illustrated, an interaction sequence disruption prediction may not be generated in circumstances that a probability output by the interaction sequence disruption prediction model does not meet or exceed the interaction sequence disruption prediction threshold. However, according to certain embodiments, and although not depicted in FIG. 3, in such circumstances an output of the model does not meet or exceed the interaction sequence disruption prediction threshold, an interaction sequence disruption prediction may be generated but may include a ‘false’ indicator, or its contents can be null. Numerous variations can be contemplated.

In circumstances in which the output meets or exceeds the interaction sequence disruption prediction threshold, the interaction sequence disruption prediction may include a directional indicator indicating a decrease or increase, a category, a predicted start time, a predicted duration, a quantifiable feature, a predicted number of interactions, a predicted number of interactions within a specified time period, a predicted deviation of the quantifiable feature in comparison to the quantifiable feature prior to a start of a predicted interaction sequence disruption, or the like. According to certain embodiments, some of the aforementioned attributes, or fields of the interaction sequence disruption prediction may be optional, not present, or not populated in certain circumstances.

As shown by operation 314, the interaction sequence disruption prediction server 150 generates, based at least in part on the interaction sequence disruption prediction, an electronic communication configured for display via a display device. The electronic communication may be generated based on one or more attributes of the interaction sequence disruption prediction. According to certain embodiments, a lookup may be performed based on one or more attributes, and a template electronic communication retrieved, for example.

According to certain embodiments, the template electronic communication may be populated with information such as from the subject entity's profile. The electronic communication may indicate a marketing opportunity, advertisement, or the like, and may include an enrollment link or other information enabling access to website or application of an interaction system 120 or interaction sequence disruption prediction server 150, to participate in the opportunity. For example, the electronic communication may include an offer for applying for a credit card that includes a reward or rebate for purchases in a certain spending category (such as a category identified in the interaction sequence disruption prediction). According to certain embodiments, the electronic communication may indicate a warning, notification or other information that deters the user from interacting with the user device 100, such that the predicted interaction sequence disruption is avoided, the extent of the disruption reduced, or the like. In examples, the communication may be selected or generated using predefined data or scripts (e.g., a lookup table or decision tree). In further examples, the communication may be selected or generated using a large language model or other artificial intelligence system to produce output based on a prompt. In some embodiments, the non-monetary events may be clustered or grouped (e.g., automatically with a clustering algorithm) or manually by their types, allowing a mapping between triggering events for a customer to specific targeted actions/communications.

Personalization need not be just given per type of events. Embodiments can identify meaningful events for each specific customer (e.g., based on their likelihood to result in a change for the user). For instance, a change of address may have high importance for one customer but low for another one. Embodiments herein can present improvements such that personalized actions are sent to only to the first customer and not the second customer.

In operation 316, in response to predicting a disruption and generating an interaction sequence disruption prediction, the interaction sequence disruption prediction server 150 transmits the electronic communication to a computing device associated with the subject entity, such as the subject entity for which the disruption is predicted. According to certain embodiments, the electronic communication is transmitted to the user device 100. Although not illustrated in FIG. 3, the electronic communication may be transmitted to the user device 100 via another device or system, such as the interaction system 120. The electronic communication may be transmitted using a variety of protocols or methods, such as electronic mail, secure messaging, or by directing rendering by an application or website with which the user device 100 interacts. Numerous variations may be contemplated.

As shown by operation 318, the user device 100 receives and displays the electronic communication. While operations 316 and 318 describe electronic communications, other mediums may be used for communication, including non-electronic communication such as physical mail.

From operation 316, the process flow may return to operation 306, such that the interaction sequence disruption prediction server 150 monitors newly received data, applies the data to the model, and generate additional interaction sequence disruption predictions and corresponding electronic communications accordingly. In this regard, data received via one or more interaction systems 104 is continually or routinely monitored, and predictions made or updated for a plurality of entities. The interaction sequence disruption prediction server 150 can therefore detect the one or more subject event indicators associated with the subject entity and the first domain based at least in part on monitoring one or more data sources, wherein the interaction sequence disruption prediction is generated in real-time relative to a detection of the one or more subject event indicators in the one or more data sources. According to certain embodiments, the interaction sequence disruption prediction server 150 generates an updated subject time series data object by updating the subject time series data object to include additional subject event indicators and respective timestamps received based at least in part on monitoring one or more data sources. Responsive to generating the updated subject time series data object, the interaction sequence disruption prediction server 150 generate, based at least in part on applying the interaction sequence disruption prediction model to the updated subject time series data object, an updated interaction sequence disruption prediction associated with the second domain.

The implementation of example embodiments within a computing environment, and using an interaction sequence disruption prediction model including a neural network, provides enhanced discoveries at a fine-grain level even within large data sets. Example embodiments therefore provide a high level of accuracy in its predictions, and can perform continuous automated improvement by updating the interaction sequence disruption prediction model and by applying the model to newly received data as it is received, to generate new predictions accordingly, such as in real-time as the data is received. Moreover, according to certain embodiments, the interaction sequence disruption prediction server 150 may store or transmit the interaction sequence disruption prediction in memory in association with the subject entity, such that one or more computing systems or subsystems can access the interaction sequence disruption prediction and perform an operation, such as generation of an electronic communication accordingly. In this regard, the interaction sequence disruption prediction server 150 may provide one or more application programming interfaces (APIs) to enable other systems to perform various processes as a result of the interaction sequence disruption prediction.

### Example Computing Environment

FIG. 4 discloses a computing environment 400 in which aspects of the present disclosure may be implemented. The computing environment 400 may implement any of the user device 100, interaction system 120, and the interaction sequence disruption prediction server 150. A computing environment 400 is a set of one or more virtual or physical computers 410 that individually or in cooperation achieve tasks, such as implementing one or more aspects described herein. The computers 410 have components that cooperate to cause output based on input.

Example computers 410 include desktops, servers, mobile devices (e.g., smart phones and laptops), wearables, virtual reality devices, augmented reality devices, expanded reality devices, spatial computing devices, virtualized devices, other computers, or combinations thereof. In particular example implementations, the computing environment 400 includes at least one physical computer.

The computing environment 400 may specifically be used to implement one or more aspects described herein. In some examples, one or more of the computers 410 may be implemented as a user device, such as mobile device and others of the computers 410 may be used to implement aspects of a machine learning framework useable to train and deploy models exposed to the mobile device or provide other functionality, such as through exposed application programming interfaces.

The computing environment 400 can be arranged in any of a variety of ways. The computers 410 can be local to or remote from other computers 410 of the computing environment 400. The computing environment 400 can include computers 410 arranged according to client-server models, peer-to-peer models, edge computing models, other models, or combinations thereof.

In many examples, the computers 410 are communicatively coupled with devices internal or external to the computing environment 400 via a network 190, such as described with respect to FIG. 1.

In some implementations, computers 410 can be general-purpose computing devices (e.g., consumer computing devices). In some instances, via hardware or software configuration, computers 410 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 410 include one or more processors 412, memory 414, and one or more interfaces 418. Such components can be virtual, physical, or combinations thereof.

The one or more processors 412 are components that execute instructions, such as instructions that obtain data, process the data, and provide output based on the processing. The one or more processors 412 often obtain instructions and data stored in the memory 414. The one or more processors 412 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 412 include at least one physical processor implemented as an electrical circuit. Example providers of processors 412 include INTEL, AMD, QUALCOMM, TEXAS INSTRUMENTS, and APPLE.

The memory 414 is a collection of components configured to store instructions 416 and data for later retrieval and use. The instructions 416 can, when executed by the one or more processors 412, cause execution of one or more operations that implement aspects described herein. In many examples, the memory 414 is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, transitory memory 414 can store information encoded in transient signals.

The one or more interfaces 418 are components that facilitate receiving input from and providing output to something external to the computer 410, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display). The one or more interfaces 418, such as a communication interface, can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, or other protocols). One or more of the one or more interfaces 418 can facilitate connection of the computing environment 400 to a network 190.

The computers 410 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Example Machine Learning Framework

FIG. 5 illustrates an example machine learning framework 500 that techniques described herein may benefit from or improve on. A machine learning framework 500 is a collection of software and data that implements artificial intelligence trained to provide output, such as predictive data, based on input. Examples of artificial intelligence that can be implemented with machine learning way include neural networks (including recurrent neural networks), language models (including so-called “large language models”), generative models, natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 500 or components thereof are often built or refined from existing frameworks, such as TENSORFLOW by GOOGLE, INC. or PYTORCH by the PYTORCH community.

The machine learning framework 500 can include one or more models 502 that are the structured representation of learning and an interface 504 that supports use of the model 502. The model 502 may include the interaction sequence disruption prediction model and can take any of a variety of forms. In many examples, the model 502 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 502 can include a representation of memory (e.g., providing long short-term memory functionality). Where the set includes more than one model 502, the models 502 can be linked, cooperate, or compete to provide output.

The interface 504 can include software procedures (e.g., defined in a library) that facilitate the use of the model 502, such as by providing a way to establish and interact with the model 502. For instance, the software procedures can include software for receiving input, preparing input for use (e.g., by performing vector embedding, such as using Word2Vec, BERT, or another technique), processing the input with the model 502, providing output, training the model 502, performing inference with the model 502, fine tuning the model 502, other procedures, or combinations thereof.

In an example implementation, interface 504 can be used to facilitate a training method 510. The training method 510 may therefore include or be used to implement operation 222 of FIG. 2. The training method 510 may include operation 512, which includes establishing a model 502, such as initializing a model 502. The establishing can include setting up the model 502 for further use (e.g., by training or fine tuning). The model 502 can be initialized with values. In examples, the model 502 can be pretrained.

Operation 514 can follow operation 512. Operation 514 includes obtaining training data, such as described with respect to one or more event indicators 204, data 208, and operations 218 and 220 of FIG. 2. In many examples, the training data includes pairs of input (e.g., training time series data objects) and desired output (e.g., interaction sequence disruption labels) given the input. In supervised or semi-supervised training, the data can be prelabeled, such as by human or automated labelers. In unsupervised learning the training data can be unlabeled.

Many examples herein are related to supervised prediction of disruptions to pinpoint the weights or importance of events. But certain embodiments may operate without explicit labels (e.g. closure of account as label) but with implicit labels computed by the raw monetary data. Thus data need not be explicitly labeled. But it can be beneficial to use an input labeler (see input processor 620) to infer labels and to train a supervised model.

The training data can include validation data used to validate the trained model 502. Operation 516 can follow operation 514. Operation 516 includes providing a portion of the training data to the model 502. This can include providing the training data in a format usable by the model 502. The machine learning framework 500 (e.g., via the interface 504) can cause the model 502 to produce an output based on the input.

Operation 518 can follow operation 516. Operation 518 includes comparing the expected output with the actual output. In an example, this can include applying a loss function to determine the difference between expected and actual data. This value can be used to determine how training is progressing. Operation 520 can follow operation 518. Operation 520 includes updating the model 502 based on the result of the comparison. This can take any of a variety of forms depending on the nature of the model 502. Where the model 502 includes weights, the weights can be modified to increase the likelihood that the model 502 will produce correct output given an input. Depending on the model 502, backpropagation or other techniques can be used to update the model 502.

Operation 522 can follow operation 520. Operation 522 includes determining whether a stopping criterion has been reached, such as based on the output of the loss function (e.g., actual value or change in value over time). In addition, or instead, whether the stopping criterion has been reached can be determined based on a number of training epochs that have occurred or an amount of training data that has been used. In some examples, satisfaction of the stopping criterion can include if the stopping criterion has not been satisfied, the flow of the method can return to operation 514. If the stopping criterion has been satisfied, the flow can move to operation 522.

Operation 522 includes deploying the trained model 502 for use in production, such as providing the trained model 502 with real-world input data and produce output data used in a real-world process, such as provided with respect to FIG. 3. The model 502 can be stored in memory 414 of at least one computer 410 or distributed across memories of two or more such computers 410 for production of output data (e.g., interaction sequence disruption predictions). The model 502 may include or implement the interaction sequence disruption prediction model and may be stored on interaction sequence disruption prediction memory 156.

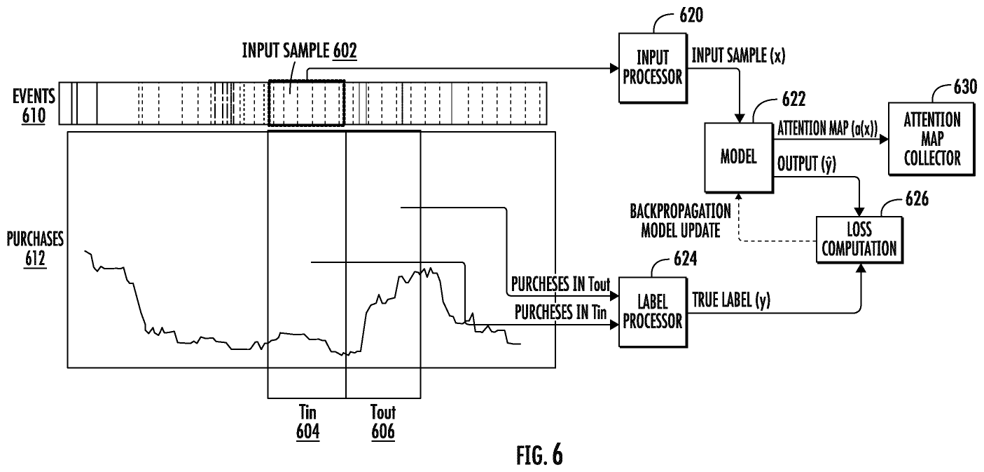

FIG. 6. depicts a process for training of the interaction sequence disruption prediction model. For example, the operations of FIG. 6 may be used to implement operation 222 of FIG. 2, and training method 510 of FIG. 5. FIG. 6 depicts the training of the interaction sequence description prediction model with regard to an input sample 602, including one or more event indicators. Given an input time window Tᵢₙ 604 and an output time window Tₒᵤₜ 606 (in this example, consecutive windows), the input, such as one or more event indicators, is based on the events 610 associated with the first domain, having occurred within Tᵢₙ. For example, the input sample 602 may be based on event indicators for one or more non-monetary events. The output is computed based on data 612, such as data representative of an interaction sequence, associated with the second domain, such as an interaction sequence comprising an entity's purchases, for example, between Tᵢₙ and Tₒᵤₜ.

The raw input sequence of events may be input to an input processor 620, or encoder, that prepares the data to be ingested by the model 622, such as the interaction sequence disruption prediction model. For example, the input processor 620 may generate one or more training time series data objects based on the event indicators of the input sample 602, such as generated with respect to operation 218 of FIG. 2, and operation 514 of FIG. 5. The label processor 624 processes data 612 associated with the second domain to generate one or more interaction sequence disruption labels, such as described with respect to operation 220 of FIG. 2, and operation 514 of FIG. 5. In the illustrated example a disruption of an interaction sequence may be detected as it appears that the user notably increased their spending in Tₒᵤₜ compared to Tᵢₙ. The generated one or more interaction sequence disruption labels, or true label y, may include any attributes of an interaction sequence disruption prediction. For example, given the illustrated example, the label may include a directional indicator of ‘increase.’ Reference to a ‘true’ label as indicated in FIG. 6 refers to actual data received by the interaction sequence disruption prediction server 150. Accordingly, training the interaction sequence disruption prediction model comprises identifying one or more target timeframes of one or more of the plurality of time series data objects as an indicator of the interaction sequence disruption labels. It will be appreciated that in certain embodiments, the label processor 624 determines no interaction sequence disruption occurred in a given time window. In such examples, such data may be omitted from the training process, however, in certain embodiments, the data may be utilized for indicating no interaction sequence disruption occurred.

Continuing with the description of FIG. 6, the model, given the input x, provides an output ŷ that can be compared to the true label y, provided by label processor 624, using loss computation 626 and used to update the model itself via backpropagation.

Using an attention mechanism, the interaction sequence disruption prediction model determines attention weights of the one or more event indicators of the plurality of training time series data objects and determines attention weights of one or more event types. The model may weight events or event types occurring in one or more target timeframes more heavily than those outside of the one or more target timeframes. The model provides its internal attention weights a(x) of the input sequence to an attention map collector 630. In this regard the operations of FIG. 6 can be used to update the model, such as with respect to operation 520 of FIG. 5.

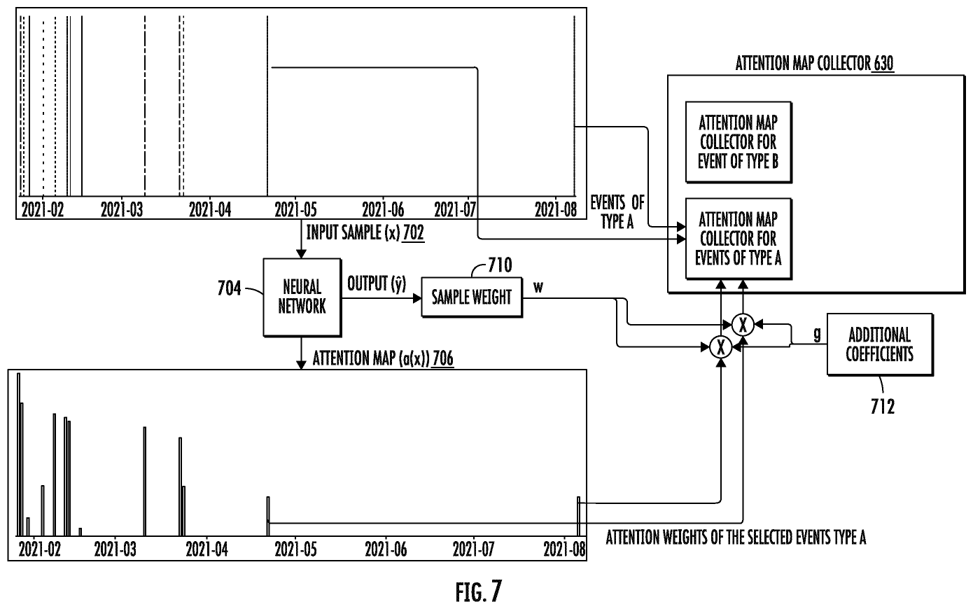

FIG. 7 illustrates collection and aggregation of the attention weights. The operations of FIG. 7 may be used in training the model, such as with respect to operation 222 of FIG. 2, and training method 510 of FIG. 5. FIG. 7 shows the collection of weights related to a target event A within input sample x 702. The input sample is shown in the top plot, showing the time occurrence (horizontal axis) of the various events, and coding each event type. The input is ingested by the model, such as neural network 704, that provides an output probability distribution and the attention map. The attention map 706 is shown in the bottom plot with the time of the events in the horizontal axis, to map the weight (vertical axis) of each input events (top plot). The output probability ŷ may be used to create a weight 710 of the sample that in turn is used to weight each attention score. Additional coefficients 712 may be used to further weight each attention score. The same process is done for each event type B, C, . . . , and for each sample in the dataset, such that the attention map collects different attention weights for different event types.

According to certain embodiments, such as embodiments utilizing a transformers model, self-attention layers may be used to provide the importance of each event in a time series data object or training time series data objects (e.g., events associated with the first domain, such as but not limited to non-monetary events). Example methods for determining weights may include on or more of
Accessing Attention Weights: access the attention weights of the transformer model, such as by accessing the weights after the model's forward pass.
Interpreting Attention Weights: According to certain embodiments, the attention weights correspond to the importance the model assigns to each element, such as an event represented in a time series data object, for the task at hand. For a specific element, attention weights are outputted as a vector, where each element of the vector corresponds to the weight of association between the element at hand and every other element in the context. Elements having highest weights should be considered more important.
Considering the Impact of Layers and Heads: Certain embodiments may utilize transformer models with more than one attention layer and head, resulting in a set of attention weights per element of a time series data object. Each layer and head learn different types of attention. Some embodiments examine the attentions from different layers and heads to get a comprehensive understanding.

In certain example embodiments employing single attention, only one set of weights for each element of the time series data object, is given by the model, which can be directly interpreted. For multi-head attention, each head will give a different set of attention weights for each element. Accordingly, certain embodiments may average the attention weights across heads, or examine them separately to understand which heads are paying attention to which parts of the time series data object.

According to certain embodiments, the interaction sequence disruption prediction model considers instances x specified by an arbitrary length sequence of non-monetary events (e₁, e₂, . . . ) included in the time series data object, and pertaining to the respective entity, where each event eᵢ is a tuple of the event timestamp tᵢ∈ [symbol] and the event type cᵢ∈{1, . . . , C}, where x=(e₁, e₂, . . . ) and eᵢ=(tᵢ,cᵢ). The model f maps x to a predicted output ŷ and an attention map a of the same length as x:

$$\hat{y} , a = f ( x )$$

According to certain embodiments, the output 9f is a vector containing a probability distribution of the sample x being classified in each class. The output 9 can be used to train the model by comparing it to the real label y.

The timestamp and the event type provide the minimal description of the event. In some embodiments, each event eᵢ may contain a plurality of features fᵢ forming a set of N features: eᵢ=(f₁, f₂ . . . fₙ). Each feature may be a numerical value, Boolean value, categorical value, textual value, etc. According to the feature type, a specific data pre-processor stage may be needed to encode each input feature into one or a set (for example in a one-hot encoding fashion) values, that will be ingested by the neural network. According to certain embodiments, the timestamp tᵢ and the event type cᵢ are considered as part of the features set.

Once the model is trained, example embodiments collect and aggregate the attention weights of the model. In this phase, for each input sample of the model, the attentions weights assigned by the model to each element of a time series data object are collected and divided by event type. According to certain embodiments, for each type of event associated with the first domain, such as non-monetary events, attention weights assigned by the model to all occurrences in all the input samples are collected. Note that an input sample may contain more than one events of the same type, and the model may assign different attention weights to each event.

According to certain embodiments, in certain circumstances the time series data object is a formed by a plurality of features and the event type is not explicitly available or it is not a granularity expected by the interaction sequence disruption servers 150. In such circumstances, example embodiments can cluster events to determine similar events that can be considered as event types. Accordingly, in a circumstance where an event type of one or more of the one or more subject event indicators is unknown, applying the interaction sequence disruption prediction model to the subject time series data object comprises clustering the one or more subject event indicators to generate one or more predicted event types. In such circumstances, the interaction sequence disruption prediction is generated further based at least in part on the one or more predicted event types.

According to certain embodiments, only the training data having as a label a predicted interaction sequence disruption (or a predicted interaction sequence disruption satisfying, meeting, or exceeding the interaction sequence disruption prediction threshold) is used to collect the underlying attention maps. Accordingly, the attention maps used by the model can discriminate the interaction sequence disruptions, while not using the weights of events in time series data objects without changes, or without associated interaction sequence disruptions.

In some embodiments, the attention scores may be weighted by the likelihood given by the model to correctly classify the sample into its real category. For instance, given a sample xᵢ classification error as errᵢ=yᵢ−ŷᵢ, by using a function as wᵢ=1−|errᵢ| to weight the attentions a, of the sample xᵢ. According to certain embodiments, additional coefficients may be used to further weight g each single attention score, for instance a function of the time of the occurrence of the event within the input window Tᵢₙ, to weight more the latest events. Accordingly, applying the interaction sequence disruption prediction model to the subject time series data object comprises assigning weights to the one or more subject event indicators according to the respective timestamps.

Accordingly, each event, such as a non-monetary event of a time series data object, can be given an average attention value within its various occurrences. Such value can be used as a metric of correlation of that specific event with an interaction sequence disruption in the and can be used to rank the events according to their higher correlation to the interaction sequence disruption.

Example operations for an embodiment of the collection of weights may include:

```
attention_weights = {“type i”: [ ] for each event type i}
For each sample xᵢ and its true label yᵢ:
    ŷᵢ, aₓᵢ = f(xᵢ)
    wᵢ = 1 − |yᵢ − ŷᵢ|
    for each event type t_{target}:
      for each eⱼ = (u, cⱼ, tⱼ) ∈ xᵢ having tⱼ =:
        attention_weights[type t_{target}].append( aₓᵢ^{j} * wᵢ * gⱼ)
for each event type t_{target}:
  attention_weights[type t_{target}] = avg(attention_weights[type t_{target}])
```

Similar operations or algorithms can be used with a plurality of features describing each event. In such cases the cluster in which each event e belongs can be used instead of the event type target.

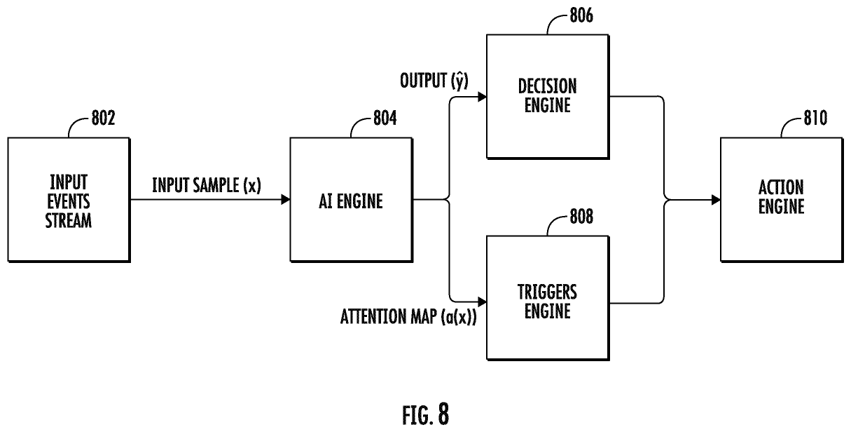

FIG. 8 shows a flowchart for marketing actions towards a user device at runtime. The input events stream 802 feeds into to the trained artificial intelligence (AI) engine 804, which outputs a prediction probability via the decision engine 806 and an attention map that is used to automatically extract triggers via the triggers engine 808. The action engine 810 determines or looks up an action accordingly, including generating and transmitting an electronic marketing communication, for example, to a user device 100. In this regard, the operations of FIG. 8 can be used to implement operations 314 and 316 of FIG. 3.

The interaction sequence disruption model can be used for a variety of tasks, actions, or communications, such as illustrated with respect to FIG. 8. According to certain embodiments, events such as the non-monetary events may be clustered or grouped (automatically with a clustering algorithm) or by their types, initiating targeted actions or communications, such as but not limited to:
Launch a joint account credit card offer with added benefits for newlyweds, such as discounts on travel, dining, and home decor stores.
Provide a special offer or discount for using the cards in local stores and restaurants in the new area, helping the customer explore their new surroundings. Promotions on dining, and home decor stores.
Promote a home improvement related cash-back or reward points program, focusing on spending at hardware stores, furniture outlets, etc.
Use the opportunity to promote other products or rewards programs available that the customer may not be aware of, based on the nature of their call and their spending habits.
Offer a temporary increase in cash-back or rewards for purchases related to baby care items, children's stores and pediatric clinics. Promote new saving accounts for the newborn.
Promote a credit limit increase or a premium version of the card with benefits that fit the new lifestyle changes like increased travel benefits or restaurant discounts.
Offer a senior's reward program with special deals at grocery stores, pharmacies, leisure activities and travel.
Provide cash back or discount on auto parts and services purchases.
Offer a temporary deferment, lower interest rate or reduction in minimum payment required to support the customer during the financial crisis.
Provide a business credit card offer with attractive points or rewards for office-related purchases, including items like office supplies, printing services, and commercial electronic.

According to certain embodiments, generating the interaction sequence disruption prediction and determining an action such as a type or template of an electronic communication, are not merely one-to-one mappings of event types to a prediction, nor mappings of event types to electronic communication types. In contrast, example embodiments identify meaningful events for each specific entity, to generate predictions and personalized actions. For instance, a change of address may have high importance for one entity with regard to a predicted interaction sequence disruption, but low importance for another entity. In such a circumstance, example embodiments initiate personalized actions to the first entity, but not the other entity. By utilizing the example methods and processes described herein, including but not limited to the disclosed example model that incorporates an attention mechanism, example embodiments generate interaction sequence disruption predictions based on an analysis of a time series data object, and by identifying a significant portion(s) thereof.

The use of a computer and network implemented system in generating the interaction sequence disruptions, and associated electronic communications, enables leveraging of machine learning processes, neural networks, and attention mechanisms to efficiently extract meaningful triggers and patterns from large datasets, including across long time frames of multiple sequenced events, by analyzing extensive variations of time windows from the large datasets. The generated predictions are also more accurate and are able to detect latent and hidden relationships between multiple sequenced events. Accordingly, example embodiments provide improvements over systems that merely provide one-to-one data triggers (e.g., marketing communications in response to a particular detected event or purchase). By incorporating events associated with a first domain (such as non-monetary events) into a model along with known interaction sequence disruptions associated with a second domain (such as changes in patterns of monetary transactions), example embodiments provide improvements over alternative models that are limited to analyzing data associated with a single domain (such as for example, models that process monetary spending to make predictions about future spending). Moreover, example embodiments provide an accurate and efficient machine learning environment for generating the interaction sequence disruption predictions that is not possible or practical to replicate in a human domain or generic computing environment.

Implementing the example embodiments provided herein, further enables portability and scalability across a wide array of computing systems. Example embodiments may be integrated with a variety of interaction systems 120, to generate meaningful and intelligent interaction sequence disruption predictions. Such integration may provide non-routine use of data from a first domain to make predictions regarding a second domain. The accuracy of such predictions may be further improved by utilizing machine learning models including attention mechanisms as described herein.

### Application of Techniques

Techniques herein may be applicable to improving technological processes of a financial institution, such as technological aspects of transactions (e.g., resisting fraud, entering loan agreements, transferring financial instruments, or facilitating payments). Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The various embodiments described herein are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims. Although specific terms are employed herein, they are used in a generic and descriptive sense only and not for purposes of limitation.

That which is claimed:

1. A system comprising one or more processors, and memory having instructions that, when executed by the one or more processors, cause the one or more processors to:
receive one or more subject event indicators associated with a subject entity and a first domain, wherein the one or more subject event indicators comprise respective timestamps;
generate, based at least in part on the one or more subject event indicators and the respective timestamps, a subject time series data object associated with the subject entity;
generate, based at least in part on applying an interaction sequence disruption prediction model to the subject time series data object, an interaction sequence disruption prediction associated with a second domain and comprising a subject disruption type and a subject directional indicator;
generate, based at least in part on the interaction sequence disruption prediction, an electronic communication configured for display via a display device; and
transmit the electronic communication to a computing device associated with the subject entity.

2. The system according to claim 1, wherein the instructions, that when executed by the one or more processors, further cause the one or more processors to:
generate a plurality of training time series data objects associated with respective entities, wherein each training time series data object comprises one or more event indicators associated with the first domain and comprising respective timestamps;
generate interaction sequence disruption labels for each of the plurality of time series data objects, wherein the interaction sequence disruption labels are associated with the second domain, and comprise disruption types and directional indicators associated with the respective entities; and
train the interaction sequence disruption prediction model with the plurality of time series data objects and the interaction sequence disruption labels, wherein the interaction sequence disruption prediction model is configured to generate interaction sequence disruption predictions.

3. The system according to claim 2, wherein the interaction sequence disruption prediction model comprises an attention mechanism, wherein training the interaction sequence disruption prediction model comprises, with the attention mechanism, determining attention weights of the one or more event indicators of the plurality of training time series data objects and determining attention weights of one or more event types.

4. The system according to claim 2, wherein training the interaction sequence disruption prediction model comprises identifying one or more target timeframes of one or more of the plurality of time series data objects as an indicator of the interaction sequence disruption labels.

5. The system according to claim 1, wherein the subject time series data object further comprises one or more subject event indicators associated with the second domain, and respective timestamps.

6. The system according to claim 1, wherein the interaction sequence disruption prediction comprises a category.

7. The system according to claim 1, wherein the interaction sequence disruption prediction comprises a predicted start time of an interaction sequence disruption.

8. The system according to claim 1, wherein the interaction sequence disruption prediction comprises a predicted duration of an interaction sequence disruption.

9. The system according to claim 1, wherein the interaction sequence disruption prediction comprises one or more of a predicted number of interactions or a predicted number of interactions per unit of time.

10. The system according to claim 1, wherein the interaction sequence disruption prediction comprises a quantifiable feature and a predicted deviation of the quantifiable feature in comparison to the quantifiable feature prior to a start of a predicted interaction sequence disruption.

11. The system according to claim 1, wherein the instructions, that when executed by the one or more processors, further cause the one or more processors to:
detect the one or more subject event indicators associated with the subject entity and the first domain based at least in part on monitoring one or more data sources, wherein the interaction sequence disruption prediction is generated in real-time relative to a detection of the one or more subject event indicators in the one or more data sources.

12. The system according to claim 1, wherein the instructions, that when executed by the one or more processors, further cause the one or more processors to:
generate an updated subject time series data object by updating the subject time series data object to include additional subject event indicators and respective timestamps received based at least in part on monitoring one or more data sources; and
responsive to generating the updated subject time series data object, generate, based at least in part on applying the interaction sequence disruption prediction model to the updated subject time series data object, an updated interaction sequence disruption prediction associated with the second domain.

13. The system according to claim 1, wherein applying the interaction sequence disruption prediction model to the subject time series data object comprises assigning attention weights to the one or more subject event indicators according to an event type of the one or more subject event indicators.

14. The system according to claim 1, wherein applying the interaction sequence disruption prediction model to the subject time series data object comprises assigning weights to the one or more subject event indicators according to the respective timestamps.

15. The system according to claim 1, wherein, in a circumstance where an event type of one or more of the one or more subject event indicators is unknown, applying the interaction sequence disruption prediction model to the subject time series data object comprises clustering the one or more subject event indicators to generate one or more predicted event types, wherein the interaction sequence disruption prediction is generated further based at least in part on the one or more predicted event types.

16. A non-transitory computer readable medium having instructions that, when executed by one or more processors, cause the one or more processors to:
receive one or more subject event indicators associated with a subject entity and a first domain, wherein the one or more subject event indicators comprise respective timestamps;
generate, based at least in part on the one or more subject event indicators and the respective timestamps, a subject time series data object associated with the subject entity;
generate, based at least in part on applying an interaction sequence disruption prediction model to the subject time series data object, an interaction sequence disruption prediction associated with a second domain and comprising a subject disruption type and a directional indicator;
generate, based at least in part on the interaction sequence disruption prediction, an electronic communication configured for display via a display device; and
transmit the electronic communication to a computing device associated with the subject entity.

17. The non-transitory computer readable medium according to claim 16, wherein the instructions, when executed by the one or more processors, further cause the one or more processors to:
generate a plurality of training time series data objects associated with respective entities, wherein each training time series data object comprises one or more event indicators associated with the first domain and comprising respective timestamps;
generate interaction sequence disruption labels for each of the plurality of time series data objects, wherein the interaction sequence disruption labels are associated with the second domain, and comprise disruption types and directional indicators associated with the respective entities; and
train the interaction sequence disruption prediction model with the plurality of time series data objects and the interaction sequence disruption labels, wherein the interaction sequence disruption prediction model is configured to generate interaction sequence disruption predictions.

18. The non-transitory computer readable medium according to claim 17, wherein the interaction sequence disruption prediction model comprises an attention mechanism, wherein training the interaction sequence disruption prediction model comprises, with the attention mechanism, determining attention weights of the one or more event indicators of the plurality of training time series data objects and determining attention weights of one or more event types.

19. The non-transitory computer readable medium according to claim 17, wherein training the interaction sequence disruption prediction model comprises identifying one or more target timeframes of one or more of the plurality of time series data objects as an indicator of the interaction sequence disruption labels.

20. A computer-implemented method comprising:
receiving one or more subject event indicators associated with a subject entity and a first domain, wherein the one or more subject event indicators comprise respective timestamps;
generating, based at least in part on the one or more subject event indicators and the respective timestamps, a subject time series data object associated with the subject entity;
generating, based at least in part on applying an interaction sequence disruption prediction model to the subject time series data object, an interaction sequence disruption prediction associated with a second domain and comprising a subject disruption type and a directional indicator;
generating, based at least in part on the interaction sequence disruption prediction, an electronic communication configured for display via a display device; and
transmitting the electronic communication to a computing device associated with the subject entity.
